(19) United States
(12) Patent Application Publication
(10) Pub. No.: US 2017/0054366 A1
(43) Pub. Date: Feb. 23, 2017

(54) CONTROL CIRCUIT AND DEVICE USING SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: JIN-SHAN MA, Shenzhen (CN); CHENG-FEI WENG, Shenzhen (CN); MENG-LIANG YANG, Shenzhen (CN)

(21) Appl. No.: 14/830,284

(22) Filed: Aug. 19, 2015

(51) Int. Cl. H02M 3/158

(52) U.S. Cl. CPC H02M 3/158

(57) ABSTRACT

A control circuit includes a control module, a trigger module and an unlock module. The control circuit is coupled to a power supply. The trigger module outputs different signals to the control module to activate or inactivate the power supply. The control circuit locks the status of the control circuit in a preset time since the power supply is activated. Thus, no matter what signal the trigger module outputs to the control module, the control module continues activating the power supply. The unlock module is used to output an unlock signal to the control module to unlock the status of the control circuit.

### FIELD

The subject matter herein generally relates to a control circuit and a device using the control circuit.

### BACKGROUND

Buttons used to turn on/off devices may be pressed unexpected.

### BRIEF DESCRIPTION OF THE DRAWINGS

Implementations of the present technology will now be described, by way of example only, with reference to the attached figures.

FIG. 1 shows a block diagram of an embodiment of a device using a control circuit.

FIG. 2 shows a circuit diagram of an embodiment of the control circuit in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to a device with a control circuit.

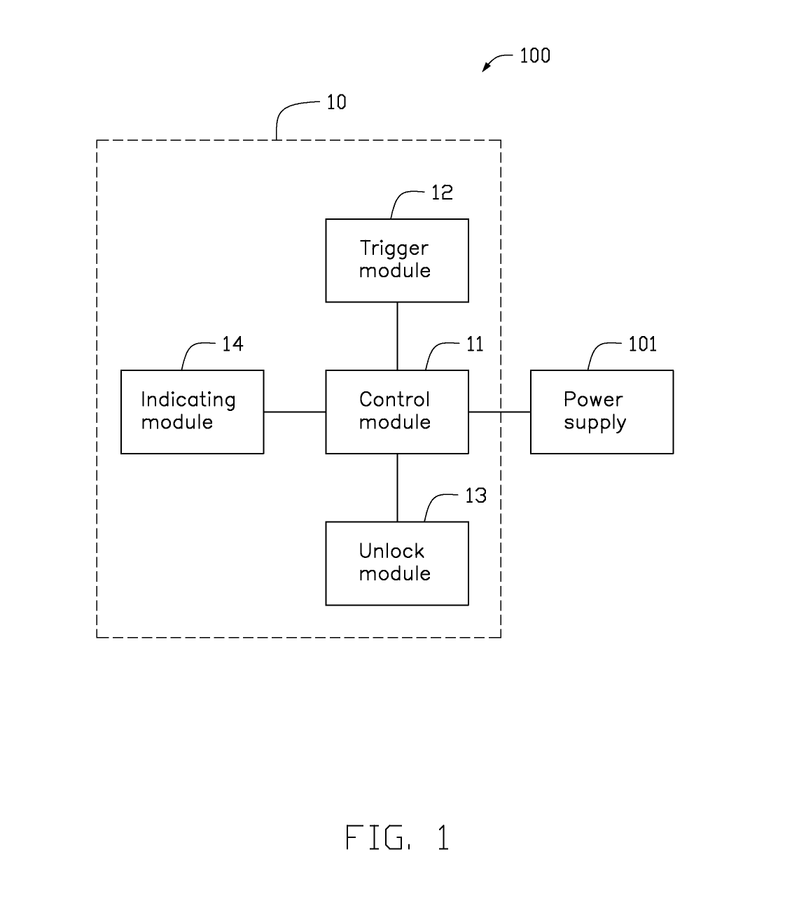

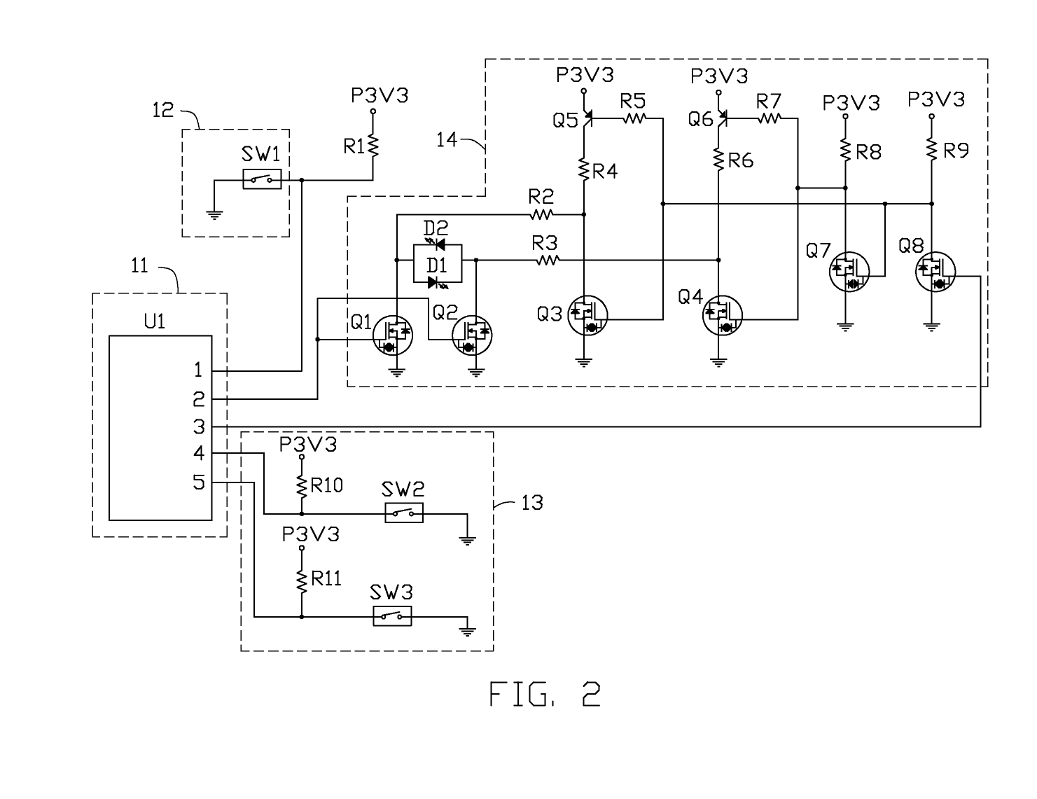

FIG. 1 and FIG. 2 show an embodiment of a control circuit 100 and a device 10 using the control circuit 100.

The control circuit 100 can comprise a control module 11, a trigger module 12, an unlock module 13, and an indicating module 14. The device 10 can comprise the control circuit 100 and a power supply 101.

The control module 11 is coupled to the trigger module 12, the unlock module 13, and the indicating module 14. The control module 11 is coupled to the power supply 101.

The trigger module 12 is used to turn on/off the device 10. The trigger module 12 outputs a first trigger signal to the control module 11 to activate the power supply 101 to turn on the device 10. The trigger module 12 outputs a second trigger signal to the control module to inactivate the power supply 101 to turn off the device 10. The control module 11 locks the status of the control circuit 100 in a preset time since the power supply is activated. Thus, no matter what signal the trigger module 12 outputs to the control module 11, the control module 11 continues activating the power supply 101.

The unlock module 13 is used to unlock the device 10 when the device 10 are operating and locked. The control module 11 locks the status of the device 10 in a preset time since the device 10 is turned on. Thus, no matter what signal the trigger module 12 outputs to the control module 11, the control module 11 continues activating the power supply 101 to keep the device 10 operating. When the control module 11 receives the unlocking signal. When the control module 11 receives the unlock signal, the first/second trigger signals from the trigger module 12 are revalidated.

The indicating module 14 is coupled to the control module 11. When the control module 11 activates the power supply 101 and the unlock module 13 does not outputs the unlocking signal to the control module 11, the indicating module 14 indicates that the device 10 is operating normally.

When the control module 11 activates the power supply 101 and the unlock module 13 outputs the unlocking signal to the control module 11, the indicating module 14 indicates that the device 10 is operating and the trigger module 12 is unlocked.

In the embodiment, the control module 11 can be an expander U1. The trigger module 12 can comprise a first switch SW1. The unlock module 13 can comprise a second switch SW2 and a third switch SW3.

A first pin 1 of the expander U1 is coupled to a first terminal of the first switch SW1. A second terminal of the first switch SW1 is grounded. The first pin 1 of the expander U1 is also coupled to a power terminal P3V3 through a first resistor R1. A second pin 2 of the expander U2 is coupled to a grid of a first field effect transistor (FET) Q1. The second pin 2 of the expander U2 is also coupled to a grid of a second FET Q2. A source of the first FET Q1 is grounded. A source of the second FET Q2 is grounded. A drain of the first FET Q1 is coupled to an anode of a first light emitting diode D1. The drain of the first FET Q1 is also coupled to a cathode of a second light emitting diode D2. The drain of the first FET Q1 is also coupled to a drain of a third FET Q3 through a second resistor R2. A drain of the second FET Q2 is coupled to a cathode of the first light emitting diode D1. The drain of the second FET Q2 is also coupled to an anode of the second light emitting diode D2. The drain of the second FET Q2 is also coupled to a drain of a fourth FET Q4 through a third resistor R3.

The drain of the third FET Q3 is coupled to a collector of a transistor Q5 through a fourth resistor R4. A source of the third FET Q3 is grounded. A grid of the third FET Q3 is coupled to a base of the transistor Q5 through a fifth resistor R5. An emitter of the transistor Q5 is coupled to the power terminal P3V3.

The drain of the fourth FET Q4 is coupled to a collector of a transistor Q6 through a sixth resistor R6. A grid of the fourth FET Q4 is coupled to a base of the transistor Q6 through a seventh resistor R7. A source of the fourth FET Q4 is grounded. An emitter of the transistor Q6 is coupled to the power terminal P3V3. The grid of the fourth FET Q4 is also coupled to the power terminal P3V3 through an eighth resistor R8. The grid of the fourth FET Q4 is also coupled to a drain of a

FET Q7. A source of the FET Q7 is grounded. A grid of the FET Q7 is coupled to the grid of the FET Q4. The grid of the FET Q7 is also a drain of the FET Q8. The drain of the FET Q8 is also coupled to the power terminal P3V3 through a ninth resistor R9. A source of the FET Q8 is grounded. A grid of the FET Q8 is coupled to a third pin 3 of the expander U1.

A fourth pin 4 of the expander U1 is grounded through the second switch SW2. The fourth pin 4 of the expander U1 is also coupled to the power terminal P3V3 through a tenth resistor R10. A fifth pin 5 of the expander U1 is grounded through the third switch SW3. The fifth pin 5 of the expander U1 is also coupled to the power terminal P3V3 through an eleventh resistor R11.

In use, the first switch SW1 is on. The first pin 1 of the expander U1 is at a low level. The expander U1 outputs a low level signal through the third pin 3. The grid of the eighth FET Q8 is at a high level. The source of the eighth FET Q8 is coupled to the drain of the eighth FET Q8. The grid of the third FET Q3 is at a low level. The grid of the fourth FET Q4 is at a low level. Thus the anode of the second light emitting diode D2 is at a high level. The cathode of the second light emitting diode D2 is at a low level. The second light emitting diode D2 is lit up to indicate that the device 10 is operating. The expander U1 outputs a positive pulse through the second pin 2 after the preset time since the first switch SW1 is on. The second light emitting diode D2 blinks to indicate that the device 10 is operating and locked. When the second switch SW2 and the third switch SW3 are turned on, the expander U1 stops outputting the positive pulse through the second pin 2. The device 10 is unlocked and the second light emitting diode D1 is lit up.

Similarly to the second light emitting diode D2, the first light emitting diode D1 can be used to indicate status of the device 10 in other working modes.

In the embodiment, the first switch SW1, the second switch SW2, and the third switch SW3 are single-pole single-throw switches. In other embodiments, the first switch SW1, the second switch SW2, and the third switch SW3 can be other components with equivalent function, such as buttons.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control circuit configured to couple a power supply, the control circuit comprising:
a control module;
a trigger module coupled to the control module; and
an unlock module used to output an unlock signal to the control module to unlock the control circuit;
wherein when the control circuit is unlocked and the trigger module outputs a first trigger signal to the control module, the control module activates the power supply; when the control circuit is unlocked and the trigger module outputs a second trigger signal to the control module, the control module inactivates the power supply; the control module locks the status of the control circuit in a preset time since the power supply is activated, no matter what signal the trigger module outputs to the control module, the control module continues activating the power supply when the control circuit is locked; when the control module receives the unlock signal from the unlock module, the control module unlocks the status of the control circuit, and the control circuit is unlocked.

2. The control circuit as claim 1, further comprising an indicating module, wherein the indicating module is used to indicate the status of the control circuit.

3. The control circuit as claim 2, wherein the indicating module comprises a first light emitting diode, when the control circuit is unlocked and the control module activates the power supply, the first light emitting diode is lit up, when the control circuit is locked and the control module activates the power supply, the first light emitting diode blinks.

4. The control circuit as claim 2, wherein the indicating module comprises a second light emitting diode, the second light emitting is used to indicate the status of the control circuit.

5. An device, comprising:
a power supply;
a control circuit comprising:
a control module;
a trigger module coupled to the control module; and
an unlock module used to output an unlock signal to the control module to unlock the control circuit;
wherein when the control circuit is unlocked and the trigger module outputs a first trigger signal to the control module, the control module activates the power supply; when the control circuit is unlocked and the trigger module outputs a second trigger signal to the control module, the control module inactivates the power supply; the control module locks the status of the control circuit in a preset time since the power supply is activated, no matter what signal the trigger module outputs to the control module, the control module continues activating the power supply when the control circuit is locked; when the control module receives the unlock signal from the unlock module, the control module unlocks the status of the control circuit, and the control circuit is unlocked.

6. The device as claim 5, wherein the control circuit further comprises an indicating module, wherein the indicating module is used to indicate the status of the control circuit.

7. The device as claim 6, wherein the indicating module comprises a first light emitting diode, when the control circuit is unlocked and the control module activates the power supply, the first light emitting diode is lit up, when the control circuit is locked and the control module activates the power supply, the first light emitting diode blinks.

8. The device as claim 5, wherein the indicating module comprises a second light emitting diode, the second light emitting is used to indicate the status of the control circuit.
